(19) United States
(12) Patent Application Publication
(10) Pub. No.: US 2012/0133836 A1
(43) Pub. Date: May 31, 2012

(54) FRAME LEVEL QUANTIZATION ESTIMATION

(75) Inventors: Anna Raffalli, Grenoble (FR); Haiyun Wang, Singapore (SG); Lucas Hui, Singapore (SG)

(73) Assignee: STMicroelectronics Asia Pacific Pte. Ltd., Singapore (SG)

(21) Appl. No.: 12/955,188

(22) Filed: Nov. 29, 2010

(51) Int. Cl. H04N 5/21

(52) U.S. Cl. 348/607; 348/E05.077

(57) ABSTRACT

A frame level noise estimate for an image can be determined. An image processor includes a high pass filter unit configured to perform high-pass spatial filtering of image data for first and second frames to produce high-pass spatially filtered information for the first frame and the second frame. A cumulative histogram generator is configured to analyze the high-pass spatially filtered information for the first frame and the second frame to produce a first cumulative histogram for the first frame and a second cumulative histogram for the second frame. A comparator is configured to determine a difference value between the first and second cumulative histograms. A mapping unit is configured to determine an estimated noise value based on the difference value.

### BACKGROUND

1. Technical Field

The techniques described herein relate to image noise reduction in the field of digital image and video processing. Some techniques relate particularly to spatially-adaptive methods for digital image decoding that can be used in high-definition television (HDTV) and set-top-box applications, for example.

2. Discussion of the Related Art

Digital images and video may be transmitted over a channel in numerous applications. One example is the transmission of digital television signals. In some applications, the digital images and video may be compressed before transmission to increase the amount of information that can be transmitted. If digital television signals are compressed, a greater number of television channels can be transmitted.

The compression of digital images and video may be lossless or lossy. When lossless compression is used, the original images or video may be exactly reproduced after decompressing the data. When lossy compression is used, the original images or video may not be reproduced exactly. The decompressed images may include noise caused by the lossy compression algorithm. In some applications, lossy compression may be preferred to lossless compression because the compression rates may be greater.

The compression of images and video may add various types of noise. One example of noise is “blocking” noise. Some compression algorithms, such as MPEG, process blocks of image and video, and various effects around block borders may cause noise to appear. Other types of noise that may occur include “ringing” or “mosquito” noise. Ringing and mosquito noise may appear near sharp edges in an image and may create noisy artifacts that extend spatially and/or temporally away from a sharp edge.

In some applications, techniques may be applied to reduce the appearance of decompression noise. For example, filters may be applied to reduce ringing noise in images and video. Applying techniques to reduce noise, however, may also adversely affect the visual content.

The strength of a filter applied to reduce noise in an image can be manually or adaptively selected based on the amount of noise in an image. For example, where an image contains a lot of noise, a stronger filter may be applied, and where an image contains a small amount of noise, a weaker filter may be applied. Applying a stronger filter to reduce noise, however, may also have greater undesirable effects on the visual content of an image. For example, the details of an image may be lost.

The amount of noise present in a compressed image can depend on the quality of the compression. The quality of the encoding can depend on size of the quantization steps that are used when compressing the image. For example, using quantization steps that are large can produce a relatively low-quality encoding that reduces the amount of data needed to encode the image. Using larger quantization steps typically increases the amount of decompression noise in the image. Using smaller quantization steps can produce a relatively high-quality encoding that preserves more details in the image, at the cost of requiring more data to encode the image.

The size of the quantization steps or amount of noise present in the image may be estimated using various techniques. Prior quantization estimation efforts have focused on the measurement of the block-wise image and compression quality rating using decoded quantization parameters. One approach to handle the issue of single-ended estimation of coding noise level in a decoded image relies on pixel-wise analysis or DCT block-based analysis on image content. Such a method does not provide appropriate estimation on frame level image quality, leading to faulty results on clean images. Another approach consists of applying a block based DCT transform to I-frames and analyzing the distribution of the resulting DCT coefficients. Another technique estimates the motion vector field of each image in the sequence to determine translational regions. The spatial distortion of each image is then predicted using the differences between the translational regions of high spatial complexity in adjacent reconstructed images. The quality of the video is obtained by pooling the spatial distortions of all images.

Thus, prior quantization estimation methods use pixel-wise or block-wise processing. However, it is difficult to determine a relationship between pixel-wise or block-wise features and the image encoding quality. In addition, these approaches may introduce side-effects on clean images as they may not be able to distinguish between the image details and the coding noise. Further, these prior techniques can be computationally demanding.

### SUMMARY

Some embodiments relate to a method of processing image frames using a processor. In the method, high-pass spatial filtering is performed on image data for first and second frames to produce high-pass spatially filtered information for the first frame and the second frame. The high-pass spatially filtered information for the first frame and the second frame are analyzed to produce first information regarding the first frame and second information regarding the second frame. The first and second frame information are compared to determine a difference value. An estimated noise value is determined based on the difference value.

Some embodiments relate to a computer readable storage medium comprising instructions, which, when executed by a processor, perform the above method.

Some embodiments relate to an image processor. The image processor includes a first unit configured to perform high-pass spatial filtering of image data for first and second frames to produce high-pass spatially filtered information for the first frame and the second frame. A cumulative histogram generator is configured to analyze the high-pass spatially filtered information for the first frame and the second frame to produce a first cumulative histogram for the first frame and a second cumulative histogram for the second frame. A comparator is configured to determine a difference value between the first and second cumulative histograms. A mapping unit is configured to determine an estimated noise value based on the difference value.

This summary is presented by way of illustration and is not intended to be limiting.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

### BRIEF DESCRIPTION OF DRAWINGS

In the drawings, each identical or nearly identical component that is illustrated in various figures is represented by a like reference character. For purposes of clarity, not every component may be labeled in every drawing.

FIG. 1 shows a block diagram of a frame level noise estimator, according to some embodiments.

FIG. 2 shows a block diagram of a randomness analyzer, according to some embodiments.

FIG. 3 shows filter coefficients that may be used in a high pass filter of a randomness analyzer, according to some embodiments.

FIG. 4 shows a curve that may be used to map the frame level noise difference into an estimate of the frame level noise, according to some embodiments.

### DETAILED DESCRIPTION

The compression of video data by various encoding standards results in the loss of information and the appearance of coding artifacts including blocking and ringing effects, mosquito noise, motion compensation (MC) mismatch, mosaic effect, etc. Frame level quantization/noise estimation can be performed to estimate the decoded/decompressed image quality, and the result can be used in subsequent spatial de-noising techniques. For example, the strength of the subsequent image filtering may be determined based on the estimated quantization/noise level of the image.

Standards for video compression specify that raw frames are compressed into certain main types of frames. Using MPEG-2 as an example, these types of frames can include intra-coded frames (I-frames), predictive-coded frames (P-frames) and bidirectionally-predictive-coded frames (B-frames). The I, P and B-frames are generated in different ways and have different characteristics. These different types of frames may be interwoven into a video sequence. It has been observed that the I and P frames show more image details as well as more ringing noise, while the B-frames are generally more blurry. The difference between the I-frame and the next B frame in a video sequence is significantly higher than the difference between two consecutive B-frames. The difference between the frame level noise of the I and B frames increases as the image is encoded using coarser encoding steps. In some embodiments, a quantization/noise level estimation for the image encoding is performed based on a frame-to-frame comparison of consecutive frames in a video sequence. In some embodiments, various image statistics are determined over the frame and an analysis of the statistics is performed at the frame level to obtain the quantization level estimate.

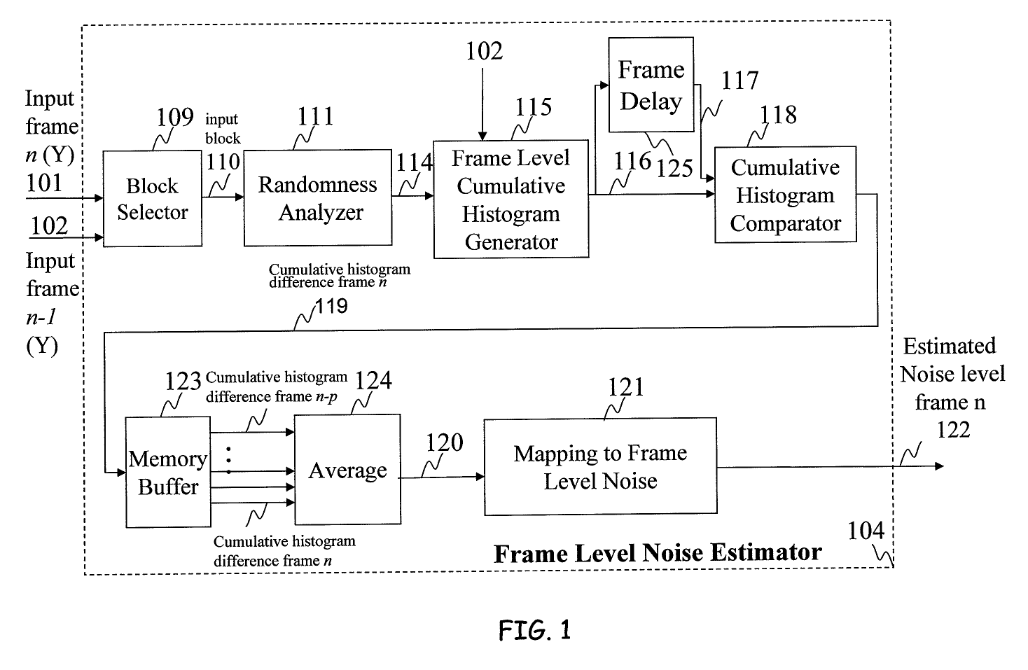

FIG. 1 shows an embodiment of a frame level noise estimator 104 that can calculate the image quantization level on a decoded image frame. The frame level noise estimator may calculate a frame-based estimate of the image quantization/noise level over the entire frame. The estimated quantization/noise level for a frame can be used to control the strength of subsequent spatial de-noising filters applied to the image frame.

As shown in FIG. 1, the frame level noise estimator 104 includes a block selector 109 that selects blocks from the image for processing, a randomness analyzer 111 that can detect the high spatial frequency content in an image frame, a cumulative histogram generator 115 that can generate the cumulative histogram of the randomness analyzer output for each frame, a frame-level cumulative histogram comparator 118 to analyze the difference of the cumulative histograms of two consecutive frames, an average unit 124 to compute the averaged histogram difference for a set of consecutive frames, and a mapping module 121 to map the averaged histogram difference into an estimate of the frame level noise in the image. The noise estimate can be used to determine the amount of filtering to be applied to the image by a subsequent spatial de-noising filter.

Digital images may contain pixels that each have associated luminance data representing the brightness of a pixel. As shown in FIG. 1, the frame level noise estimator 104 receives luminance data 101 that provides the luminance values for a first image frame and for a subsequent image frame which may be the next consecutive image frame in a stream of video. In some embodiments, luminance data 101 may include the luminance values for an I-frame, a P-frame or a B-frame, and luminance data 102 may include the luminance values for the next consecutive frame. The differences between the noise content of each pair of adjacent frames may be analyzed to determine an estimate of the noise caused by quantization during image encoding.

An image frame can be divided up into a plurality of blocks of pixels having any suitable shapes or sizes. For example, a block may include a 16×16 array of pixels, in some embodiments. Luminance data 101 and 102 are provided to block selector 109 which may select the current block 110 based on the current input block coordinates 102. Since the main differences between consecutive I and B frames may be in the high spatial frequency components, the current block 110 can be provided to a randomness analyzer 111 that extracts the high spatial frequency components of the luminance information.

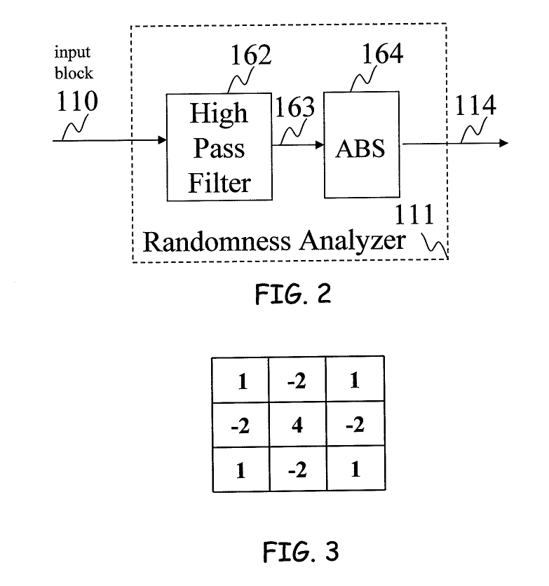

FIG. 2 shows a block diagram of randomness analyzer 111 according to some embodiments. As shown in FIG. 2, the randomness analyzer 111 includes a high pass filter 162 and an absolute value calculation unit 164. High pass filter 162 may receive the luminance information of block 110 and perform a high pass filtering operation that attenuates the low spatial frequency components of the luminance information. In some embodiments, the high pass filtering operation can be performed using a 3×3 diamond high pass filter. The filtering may be performed according to the following equation:

$$R = {\sum }_{j} {w}_{{D}_{j}} \times {P}_{j}$$

where W_{Dj} is the filter mask value of a pixel j with the luminance value Pⱼ. FIG. 3 shows the numerical values W_{D} for one example of diamond high-pass filter that may be applied to the nine pixels in a 3×3 processing window, with the center pixel being the current pixel of interest. The window can be shifted so that it is centered on each successive pixel within the frame, and the resulting values are summed as shown in the above equation. In order to exclude blocking artifacts from the analysis, the filtering may be implemented within each block. In some embodiments, the boundary of the block may be padded by boundary pixels. Another alternative is to use two additional pixel rows and columns of data around the block boundary. However, any suitable filtering technique may be used.

The filtered result R 163 may be provided to an absolute value calculation unit 164. Absolute value calculation unit 164 may determine the absolute value of each value in the filtered result R. The output 114 of the absolute value calculation unit 164 is the absolute value of the high-pass spatially filtered luminance information.

As shown in FIG. 1, the frame level noise estimator 104 also includes a frame level cumulative histogram generator 115. Cumulative histogram generator 115 can generate a cumulative histogram of the randomness analyzer output 114 for each frame. The cumulative histogram generator 115 can count the number of pixels in output 114 having various values. For example, determining the cumulative histogram may include counting the number of pixels in each bin, where each possible filtered luminance value corresponds to a different bin. Since the histogram is cumulative in nature, the numbers in previous bins may be added to the values calculated for subsequent bins. For example, values in subsequent bins can be accumulated starting with the lowest filtered luminance value. In some embodiments, the cumulative histogram can be determined for every block of the frame. After calculating the cumulative histogram for the last block of a frame, the cumulative histograms for individual blocks can be summed to produce the final cumulative histogram 116 over the entire frame.

The cumulative histogram 116 for the current frame and the cumulative histogram 117 for the previous frame can be provided to cumulative histogram comparator 118. The cumulative histogram for the previous frame may be stored, and a frame delay 125 may occur in which the cumulative histogram 117 is retrieved. The cumulative histogram comparator 118 can compare the cumulative histograms of the current frame 116 and of the previous frame 117. The cumulative histogram comparator 118 may determine the difference between the cumulative histograms for two frames. For example, the cumulative histogram comparator 118 can determine the difference between the cumulative histograms for consecutive frames, such as an I-frame and the next B-frame. One suitable method of determining the difference between the cumulative histograms is to determine the absolute value of the difference between corresponding bins in the two cumulative histograms. The absolute values may then be summed over all of the bins to determine a cumulative histogram difference CHD. For example, the following equation may be used to calculate the cumulative histogram difference CHD.

$$C H {D}_{frame\_n} = {\sum }_{j = 0}^{max\_bin} \vert {CumulativeHisto}_{frame\_n} [ j ] - {CumulativeHisto}_{frame\_ ( n - 1 )} [ j ] \vert$$

where CHD_{frame}_{_{—}}ₙ is the cumulative histogram difference calculated between frame n and frame n−1, j represents the histogram bin number, and max bin is the maximum bin number.

The value CHD_{frame}_{_{—}}ₙ may be provided to a memory buffer 123. The memory buffer 123 may store the cumulative histogram difference for the current frame and p previous frames. An average unit 124 can compute the average cumulative histogram difference 120 of the (p+1) CHD values. Any suitable number of cumulative histogram difference values can be averaged by average unit 124. The following equation may be used to calculate the average cumulative histogram difference AverageCHDₙ 120.

$$AverageC {HD}_{n} = \frac{1}{p + 1} {\sum }_{j = n - p}^{n} C H {D}_{frame\_j}$$

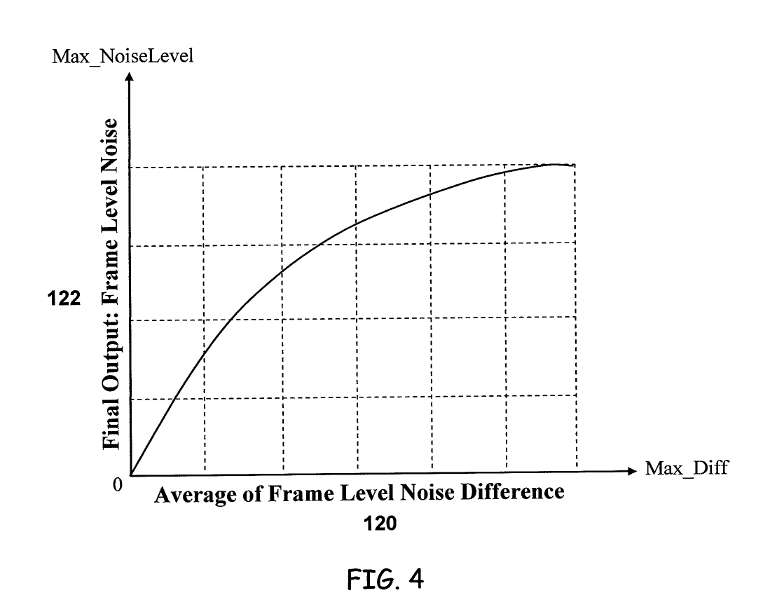

The average cumulative histogram difference 120 can be provided to the mapping unit 121. Mapping unit 121 can map the average cumulative histogram 120 into an estimated frame level noise value 122. FIG. 4 shows an example of a mapping curve that may be used to map the average cumulative histogram difference 120 into an estimate of the frame level noise 122. The mapping curve shown in FIG. 4 was experimentally generated using 40 training sequences with 50 frames per sequence by the following method.

For each frame n (where nε[0:50]) of each sequence verifying n≧p, the reference noise may be calculated as:

$${RefNoiseLevel}_{frame\_n} = \frac{1}{( p + 1 ) \times MCNum} {\sum }_{i = n - p}^{n} {\sum }_{j = 0}^{MCNum - 1} {QStep}_{i , j}$$

where RefNoiseLevel_{frame}_{_{—}}ₙ is the reference value of frame level noise on the current frame n, (p+1) is the number of frames used for calculating the average value, MCNum is the total number of macro-blocks per frame, and Qstep_{i,j} is the quantization step used for macro-block j of frame i.

The average of the cumulative histogram difference AverageCHD for the same (p+1) frames is computed as described above. This leads to the generation of a pair of data (AverageCHD, RefNoiseLevel)_{frame}_{_{—}}ₙ for each frame. Based on these values, the function RefNoiseLevel_{frame}_{_{—}}ₙ=f (AverageCHD_{frame}_{_{—}}ₙ) as shown in FIG. 4 has been determined.

The techniques described herein provide a frame level quantization estimation methodology based on analysis of the decompressed digital images. The quantization level of each image in a video sequence can be efficiently estimated by detecting frame level noise, and further by conducting a statistical analysis and curve mapping based on the difference of frame level noise over a group of successive frames. This method has a good trade-off between performance and complexity. This methodology can be applied both on the original size and the up-rescaled size of the decompressed image.

The above-described embodiments of the present invention and others can be implemented in any of numerous ways. For example, any of the components of frame level noise estimator 104 and other components may be implemented using hardware, software or a combination thereof. When implemented in hardware, any suitable image processing hardware may be used, such as general-purpose or application-specific hardware. When implemented in software, the software code can be executed on any suitable hardware processor or collection of hardware processors, whether provided in a single computer or distributed among multiple computers.

Some embodiments include at least one tangible non-transitory computer-readable storage medium (e.g., a computer memory, a floppy disk, an optical disk, a tape, etc.) encoded with a computer program (i.e., a plurality of instructions), which, when executed on a processor, perform the above-discussed functions. In addition, it should be appreciated that the reference to a computer program which, when executed, performs the above-discussed functions, is not limited to an application program running on a host computer. Rather, the term computer program is used herein in a generic sense to reference any type of computer code (e.g., software or microcode) that can be employed to program a processor to implement the above-discussed aspects of the techniques described herein.

This invention is not limited in its application to the details of construction and the arrangement of components set forth in the foregoing description or illustrated in the drawings. The invention is capable of other embodiments and of being practiced or of being carried out in various ways. Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A method of processing image frames using a processor, the method comprising:
performing high-pass spatial filtering of image data for first and second frames to produce high-pass spatially filtered information for the first frame and the second frame;
analyzing the high-pass spatially filtered information for the first frame and the second frame to produce first information regarding the first frame and second information regarding the second frame;
comparing the first and second frame information to determine a difference value; and
determining an estimated noise value based on the difference value.

2. The method of claim 1, wherein the difference value is a first difference value, and the method further comprises:
performing high-pass spatial filtering of image data for third and fourth frames to produce high-pass spatially filtered information for the third frame and the fourth frame;
analyzing the high-pass spatially filtered information for the third frame and the fourth frame to produce third information regarding the third frame and fourth information regarding the fourth frame;
comparing the third and fourth frame information to determine a second difference value; and
determining an average difference value using the first and second difference values; and
wherein the estimated noise value is determined based on the average difference value.

3. The method of claim 1, wherein the first frame is a first type of image frame and the second frame is a second type of image frame, and wherein the second frame is a next consecutive frame after the first frame in a video stream.

4. The method of claim 3, wherein the first type of frame is an I-frame, B-frame or P-frame and the second type of frame is an I-frame, B-frame or P-frame different from the first type of frame.

5. The method of claim 1, wherein the first information regarding the first frame comprises a histogram of the high-pass spatially filtered information for the first frame.

6. The method of claim 5, wherein the histogram is a cumulative histogram that is determined for the entire first frame.

7. The method of claim 5, wherein the second information regarding the second frame comprises a cumulative histogram of the high-pass spatially filtered information for the second frame.

8. The method of claim 7, wherein the difference value is determined by summing absolute values of differences between corresponding bins of the cumulative histogram for the first frame and the cumulative histogram for the second frame.

9. A computer readable storage medium comprising instructions, which, when executed by a processor, perform a method of processing image frames, the method comprising:
performing high-pass spatial filtering of image data for first and second frames to produce high-pass spatially filtered information for the first frame and the second frame;
analyzing the high-pass spatially filtered information for the first frame and the second frame to produce first information regarding the first frame and second information regarding the second frame;
comparing the first and second frame information to determine a difference value; and
determining an estimated noise value based on the difference value.

10. The computer readable storage medium of claim 9, wherein the difference value is a first difference value, and the method further comprises:
performing high-pass spatial filtering of image data for third and fourth frames to produce high-pass spatially filtered information for the third frame and the fourth frame;
analyzing the high-pass spatially filtered information for the third frame and the fourth frame to produce third information regarding the third frame and fourth information regarding the fourth frame;
comparing the third and fourth frame information to determine a second difference value; and
determining an average difference value using the first and second difference values; and
wherein the estimated noise value is determined based on the average difference value.

11. The method of claim 9, wherein the first frame is a first type of image frame and the second frame is a second type of image frame, and wherein the second frame is a next consecutive frame after the first frame in a video stream.

12. The method of claim 11, wherein the first type of frame is an I-frame, B-frame or P-frame and the second type of frame is an I-frame, B-frame or P-frame different from the first type of frame.

13. The method of claim 9, wherein the first information regarding the first frame comprises a histogram of the high-pass spatially filtered information for the first frame.

14. The method of claim 13, wherein the histogram is a cumulative histogram that is determined for the entire first frame.

15. The computer readable storage medium of claim 13, wherein the second information regarding the second frame comprises a cumulative histogram of the high-pass spatially filtered information for the second frame.

16. The computer readable storage medium of claim 15, wherein the difference value is determined by summing absolute values of differences between corresponding bins of the cumulative histogram for the first frame and the cumulative histogram for the second frame.

17. An image processor, comprising:
a first unit configured to perform high-pass spatial filtering of image data for first and second frames to produce high-pass spatially filtered information for the first frame and the second frame;
a cumulative histogram generator configured to analyze the high-pass spatially filtered information for the first frame and the second frame to produce a first cumulative histogram for the first frame and a second cumulative histogram for the second frame;
a comparator configured to determine a difference value between the first and second cumulative histograms; and
a mapping unit configured to determine an estimated noise value based on the difference value.

18. The image processor of claim 17, further comprising an average unit configured to compute an averaged histogram difference for a set of consecutive frames.

19. The image processor of claim 18, further comprising a memory buffer that stores difference values for the set of consecutive frames

20. The image processor of claim 17, wherein the first unit comprises an absolute value calculation unit.
